(19) United States
(12) Patent Application Publication
(10) Pub. No.: US 2003/0171907 A1
(43) Pub. Date: Sep. 11, 2003

(54) Methods and Apparatus for Optimizing Applications on Configurable Processors

(76) Inventors: Shay Gal-On, Palo Alto, CA (US); Steven Novack, Charlotte, NC (US)

Correspondence Address: RAUSCHENBACH PATENT LAW GROUP, LLC, P.O. BOX 387, BEDFORD, MA, 01730, US

(21) Appl. No.: 10/248,939

(22) Filed: Mar. 4, 2003

Related U.S. Application Data
(60) Provisional application No. 60/362,214, filed on Mar. 6, 2002.

(51) Int. Cl. G06F 17/50; G06F 9/45

(52) U.S. Cl. 703/14; 717/158

(57) ABSTRACT

The methods and apparatus of the present invention are directed to optimizing configurable processors to assist a designer in efficiently matching a design of an application and a design of a processor. In one aspect, methods and apparatus according to the present invention optimize a hardware architecture having one or more application specific processors. The methods and apparatus include modeling one or more of the application specific processors to generate a simulated hardware architecture and analyzing a compiled program for the simulated hardware architecture to determine one or more resource parameters for one or more program sections of the compiled program. The methods and apparatus provide one or more suggestions for modifying one or more of the application specific processors and the program sections in response to the resource parameter to optimize one or both of the compiled program and the hardware architecture.

### CROSS REFERENCE TO RELATED APPLICATIONS

This application claims priority to provisional patent application Serial No. 60/362,214, entitled “Methods and Apparatus for Optimizing Configurable Processors”, filed on Mar. 6, 2002, the entire disclosure of which is incorporated herein by reference.

### BACKGROUND OF INVENTION

Custom integrated circuits are widely used in modern electronic equipment. The demand for custom integrated circuits is rapidly increasing because of the dramatic growth in the demand for highly specific consumer electronics and a trend towards increased product functionality. Also, the use of custom integrated circuits is advantageous because custom circuits reduce system complexity and, therefore, lower manufacturing costs, increase reliability and increase system performance.

There are numerous types of custom integrated circuits. One type consists of programmable logic devices (PLDs), including field programmable gate arrays (FPGAs). FPGAs are designed to be programmed by the end designer using special-purpose equipment. PLDs are, however, undesirable for many applications because they operate at relatively slow speeds, have a relatively low level of integration, and have relatively high cost per chip.

Another type of custom integrated circuit is an application-specific integrated circuit (ASIC). Gate-array based and cell-based ASICs are often referred to as “semi-custom” ASICs. Cell-based ASICs are programmed by either defining the placement and interconnection of a collection of predefined logic cells which are used to create a mask for manufacturing the integrated circuit. Gate-array based ASICs are programmed by defining the final metal interconnection layers to lay over a predefined pattern of transistors on the silicon. Semi-custom ASICs can achieve high performance and a high level of integration, but can be undesirable because they have relatively high design costs, have relatively long design cycles (the time it takes to transform a defined functionality into a mask), and relatively low predictability of integrating into an overall electronic system.

Another type of custom integrated circuit is referred to as application-specific standard parts (ASSPs), which are non-programmable integrated circuits that are designed for specific applications. These devices are typically purchased off-the-shelf from integrated circuit suppliers. ASSPs have predetermined architectures and input and output interfaces. They are typically designed for specific products and, therefore, have short product lifetimes.

Yet another type of custom integrated circuit is referred to as a software-only architecture. This type of custom integrated circuit uses a general-purpose processor and a high-level language compiler. The designer programs the desired functions with a high-level language. The compiler generates the machine code that instructs the processor to perform the desired functions. Software-only designs typically use general-purpose hardware to perform the desired functions and, therefore, have relatively poor performance because the hardware is not optimized to perform the desired functions.

A relatively new type of custom integrated circuit uses a configurable processor architecture. Configurable processor architectures allow a designer to rapidly add custom logic to a circuit. Configurable processor circuits have relatively high performance and provide rapid time-to-market. There are two major types of configurable processor circuits. One type of configurable processor circuit uses configurable Reduced Instruction-Set Computing (RISC) processor architectures. Another type of configurable processor circuit uses configurable Very Long Instruction Word (VLIW) processor architectures.

RISC processor architectures reduce the width of the instruction words to increase performance. Configurable RISC processor architectures provide the ability to introduce custom instructions into a RISC processor in order to accelerate common operations. Some configurable RISC processor circuits include custom logic for these operations that is added into the sequential data path of the processor. Configurable RISC processor circuits have a modest incremental improvement in performance relative to non-configurable RISC processor circuits.

The improved performance of configurable RISC processor circuits relative to ASIC circuits is achieved by converting operations that take multiple RISC instructions to execute and reducing them to a single operation. However, the incremental performance improvements achieved with configurable RISC processor circuits are far less than that of custom circuits that use custom logic blocks to produce parallel data flow.

VLIW processor architectures increase the width of the instruction words to increase performance. Configurable VLIW processor architectures provide the ability to use parallel execution of operations. Configurable VLIW processor architectures are used in some state-of-the art Digital Signal Processing (DSP) circuits.

The parallel execution of operations or parallelism can be modeled by considering a processor to be a set of functional units or resources, each capable of executing a specific operation in any given clock cycle. These operations can include addition, memory operations, multiply and accumulate, and other specialized operations, for example. The degree of parallelism varies from a single operation per cycle RISC processor to a multiple operation per cycle VLIW architecture.

Designers make compromises regarding the appropriate mix of resources, the organization of the selected resources, and the efficient use of resources. Designers also make compromises regarding chip size, power requirements, and performance. For example, to achieve better performance at lower clock frequencies, DSP applications can utilize large amounts of instruction-level parallelism. Such instruction level parallelism can be achieved using various software pipelining techniques. Implementing software pipelining techniques, however, requires a processor configuration having the right mix of parallel resources. Additional hardware resources can be added to the processor to further increase performance.

However, every resource added to the processor has an associated cost in terms of die size, power, and clock frequency. Consequently, there are compromises between cost and performance. Processors can be optimized by determining the best compromise between cost and performance for the particular processor.

### BRIEF DESCRIPTION OF DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 illustrates a schematic block diagram for an optimization system including a computer system for optimizing a hardware architecture having one or more application specific processors (ASPs) according to one embodiment of the present invention.

FIG. 2 illustrates a schematic block diagram of a multi-processor hardware architecture that includes two task processors that are in communication with a distributed shared memory and data and instruction memories according to one embodiment of the present invention.

FIG. 3 illustrates a flow chart of a method to develop an ASP according to one embodiment of the present invention.

FIG. 4 illustrates a graphical display showing various panels indicating assorted performance parameters according to an embodiment of the present invention.

FIG. 5 illustrates an example of an analysis panel according to an embodiment of the invention.

FIG. 6 illustrates a graphical display indicating a performance analysis including static and dynamic utilization for a specific system processor according to an embodiment of the present invention.

FIG. 7 illustrates a graphical display indicating data allocation suggestions for the voice processing system example described herein.

FIG. 8 presents an example of a suggested configuration for a system according to the present invention that will reduce bottlenecks.

FIG. 9 illustrates a flowchart of a method according to an embodiment of the present invention for finding resource bottlenecks for pipelined loops.

FIG. 10 illustrates a flowchart of a method according to an embodiment of the present invention for finding resource bottlenecks for any block that is not part of a pipelined loop.

### DETAILED DESCRIPTION

Software profiling tools or profilers can reveal and optimize dynamic software bottlenecks. Some of these profilers determine where bottlenecks reside and can provide advice on optimizing the software to reduce the bottlenecks. Since these profilers assume that the software application is flexible and that the processor is fixed, these profilers are designed to optimize the software only.

The methods and apparatus for optimizing configurable processors according to the present invention analyze both the hardware and the software of configurable processors relative to performance and cost restraints. The methods and apparatus then make recommendations for reconfiguring the hardware and/or the software to optimize the combination of the hardware and the software in view of the performance and cost restraints.

Designers of configurable processors can use the methods and apparatus of the present invention to efficiently match an application with a processor by determining the optimal design compromises between cost and performance. Designers can also use the methods and apparatus of the present invention to optimize the configurable processor for particular applications. For example, designers can use the methods and apparatus of the present invention to optimize configurable DSP processors.

The methods and apparatus of the present invention are independent of the number of processors and independent of the number of shared and private data memory resources. Additionally, the methods and apparatus of the present invention can utilize a graphical user interface (GUI), which allows a designer, for example, to view statistics, results, and analyses. Additionally, the GUI allows the designer to input “what-if” scenarios and view the results essentially in real time.

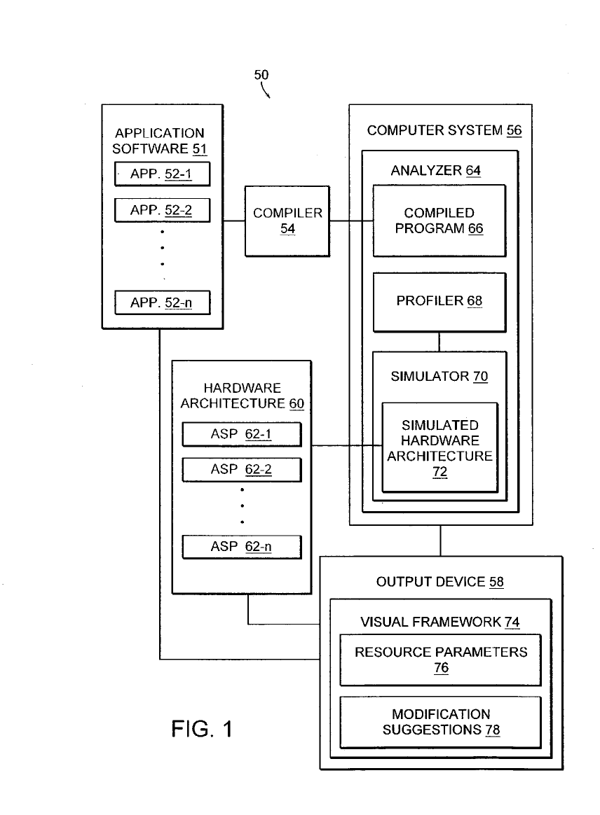

Referring more particularly to the figures, FIG. 1 illustrates a schematic block diagram for an optimization system 50 including a computer system 56 for optimizing a hardware architecture 60 having one or more application specific processors (ASPs) 62-1, 62-2, through 62-n (referred to generally as 62), according to one embodiment of the present invention. The optimization system 50 also includes application software 51 including one or more applications 52-1, 52-2 through 52-n (referred to generally as 52), a compiler 54 for the application 52, an analyzer 64 associated with the computer system 56, and an output device 58 in communication with the computer system 56.

The hardware architecture 60, in one embodiment, represents a functional design to be implemented in hardware, such as one or more configurable processors, and may include designs for one or more application specific processors 62. The software application 52 is a set of instructions designed for use with an application specific processor 62. For example, application 52-2 is designed for use with ASP 62-2. In one embodiment, the software application 52 is coded in assembly language code. In another embodiment, the software application 52 is coded in a high level language, such as Java or C. In one embodiment, the software application 52 is embedded in an implementation of the application specific processor 62. The implementation of the application specific processor 62 executes the instructions for the software application 52 to accomplish a task, for example, DSP.

The compiler 54 is a software compiler suitable for compiling the instructions (e.g., software code) for the software application 52 to produce a compiled program 66. In one embodiment, if there are multiple software applications 52, the compiler 54 compiles multiple compiled programs 66, one for each software application 52. The compiled program 66 has one or more program sections (not shown). In another embodiment, the compiler 54 compiles software instructions for the software application 52 that are coded in a high level programming language, such as Java or C. In one embodiment, the compiler 54 is a retargetable compiler that loads in the target native platform (for example, an application specific processor 62), and compiles the application 52 to perform optimally on the target platform. In another embodiment, if the software application 52 is coded in assembly language code, then an assembler (not shown) assembles the instructions of the software application 52 into an assembled program (not shown), which is equivalent to the compiled program 66 for the methods and apparatus of the present invention as described herein.

The computer system 56 is, in one embodiment, a digital computer having one or more input devices (for example, keyboard and mouse) (not shown), a digital microprocessor (not shown), a memory such as RAM or random access memory (not shown), and data storage such as a hard disk (not shown). The computer system 56, in one embodiment, is a desktop computer. In another embodiment, the computer system 56 is a distributed computing system, for example, having a client computer, a server computer, and a data storage device connected by a network, such as a local area network (LAN).

The analyzer 64 is a software or hardware module associated with the computer system 56. The analyzer 64 includes a profiler 68 in communication with a simulator 70. The profiler 68 analyzes the compiled program 66, which the computer system 56 receives from the compiler 54 and makes available to the analyzer 64 and the profiler 68. In one embodiment, the microprocessor of the computer system 56 executes the compiler 54 (not shown). In another embodiment, the compiler 54 is located on another computer system (not shown), which transfers the compiled program 66 to the computer system 56. In another embodiment, the compiler 54 is part of the analyzer 64 (not shown). The simulator 70 models the application specific processor 62 to generate a simulated hardware architecture 72. In one embodiment, the simulator 70 is an instruction set simulator that simulates the performance on a simulated ASP in the simulated hardware architecture 72 of an instruction set based on the compiled program 66.

In one embodiment, the microprocessor of the computer system 56 executes the analyzer 64. In other embodiments, the analyzer 64 is an integrated circuit, PLD, FPGA, ASIC, ASSP, or configurable processor. In other embodiments, one or more components (e.g., 68, 70) of the analyzer 64 are implemented in software, and one or more components (e.g., 68, 70) of the analyzer 64 are implemented in hardware.

The output device 58 is any output device suitable for use with the computer system 56, including, but not limited to, cathode ray tube (CRT) displays, flat panel displays (plasma or LCD), printing (hard copy) output devices, and other suitable devices. In one embodiment, the output device 58 includes audio output capabilities, such as an audio speaker.

The output device 58 includes a visual framework 74, such as a graphic user interface (not shown), that displays one or more resource parameters 76 for one or more program sections of the compiled program 66 that the profiler 68 has analyzed. The output device 58 also displays modification suggestions 78 provided by the profiler 68 for modifying the application specific processor 62 and/or one or more of the program sections of the compiled program 66 to optimize the compiled program 66 and/or the hardware architecture 60. In one embodiment, the designer modifies one or both of the application 52 and the application specific processor 62 based on one or more suggestions 78 provided by the profiler 68. In one embodiment, the designer uses a configurable processor definition tool (not shown) to modify the hardware architecture 60 and one or more application specific processors 62 included in the hardware architecture 60 based on the suggestions 78.

The methods and apparatus of the present invention can be used to analyze and profile hardware architectures 60. One aspect of the present invention is embodied in an apparatus for optimizing a hardware architecture 60 that includes one or more of the application specific processors 62. The apparatus includes the computer system 56. The computer system 56 also includes the simulator 70, which models one or more of the application specific processors 62 to generate the simulated hardware architecture 72. The computer system 56 also includes the profiler 68, which is in communication with the simulator 70. The profiler 68 analyzes the compiled program for the simulated hardware architecture 72 to determine one or more resource parameters 76 for one or more program sections of the compiled program 66. The profiler 68 provides one or more suggestions 78 for modifying one or more of the application specific processors 62 and program sections in response to one or more of the resource parameters 76 to optimize one or both of the compiled program 66 and the hardware architecture 60.

In another aspect, the present invention is embodied in a method for optimizing a hardware architecture 60 having one or more of the application specific processors 62. The method includes modeling one or more of the application specific processors 62 to generate the simulated hardware architecture 72 and analyzing the compiled program 66 for the simulated hardware architecture 72 to determine one or more resource parameters 76 for one or more program sections of the compiled program 66. The method also includes providing one or more suggestions 78 for modifying one or more of the application specific processors 62 and program sections in response to one or more of the resource parameters 76 in order to optimize one or both of the compiled program 66 and the hardware architecture 60.

In one embodiment, such hardware architectures 60 include modern computer architectures that enable the parallel execution of a few operations per operational cycle. The parallelism can be modeled by considering a computer chip to be a set of functional units or resources, each one of them ready to accomplish a specific task per cycle (e.g. add two values, read memory, multiply and accumulate). The degree of parallelism varies from minimal, e.g. executing two tasks per cycle, to maximal as exhibited by Very Long Instruction Word (VLIW) architectures.

For example, DSP processors exist that can be configured to execute a dozen units per cycle, where each functional unit executes the machine operation (mop) contained in its reserved slot inside the Very Long Instruction Word. Such DSP processors are described in co-pending U.S. patent application Ser. No. 09/480,087 entitled “Designer Configurable Multi-Processor System,” filed on Jan. 10, 2000, which is assigned to the present assignee. The entire disclosure of U.S. patent application Ser. No. 09/480,087 is incorporated herein by reference.

One method of increasing performance in VLIW processors is to reduce idle time in functional units by optimally filling the slots inside the VLIW and by simultaneously reducing the number of instruction words. In some cases, inefficiencies can be found in code loops. Code loops are herein defined as code regions that are executed many times in a repetitive manner. One approach to increasing performance is to optimize performance relative to timing constraints that are caused by functional unit competition over a limited set of shared resources (registers, memory, etc.).

These timing constraints can result in execution bottlenecks. The term “execution bottleneck” is defined herein to mean a relatively high demand for processing resources that results in longer execution time. The major goal of optimizing a demanding embedded application, such as a digital telephony application or a voice processing system (VPS), is the reduction of execution bottlenecks.

In one aspect, the methods and apparatus of the present invention evaluate software/hardware alternatives to allow the optimization of an application to run on configurable processors including application specific processors 62 (ASPs). State of-the-art ASPs 62 are designed to perform one particular application. One feature of such ASPs 62 is that both the software and the hardware can be extensively configured to optimize one particular application. Special units, referred to as “Designer Defined Computational Units (DDCUs)”, can be built and incorporated in the system to efficiently perform a specific operation, such as a fast Fourier transform, for example.

One aspect of the present invention includes the visual framework 74 that allows the designer to visualize execution bottlenecks, and gain insight from the visualization as to the cause of the execution bottlenecks. In one embodiment, the analyzer 64 graphs and displays the utilization of hardware units to indicate profile information for the analysis of both static and dynamic execution bottlenecks. For example, color or cross-hatching in the graphics display of the visual framework 74 indicates the profile information. The visual framework 74 can include a graphical user interface (GUI). The methods and apparatus of the present invention can also include various audio prompts in the analysis of the static and dynamic bottlenecks.

In one aspect, the invention is embodied in passive tools that detect and visualize execution bottlenecks. In another aspect, the invention is embodied in proactive tools that function as an assistant to the designer, proposing modification suggestions 78 for reconfiguration and augmentation of hardware to meet performance goals.

For example, when modifying the hardware for a particular application, a designer typically considers the effects on power consumption and device area of the ASP 62. The methods and apparatus of the present invention can assist the designer by providing a visual display that estimates these effects. The designer can then consider these estimates and the performance compromises associated with the hardware modification.

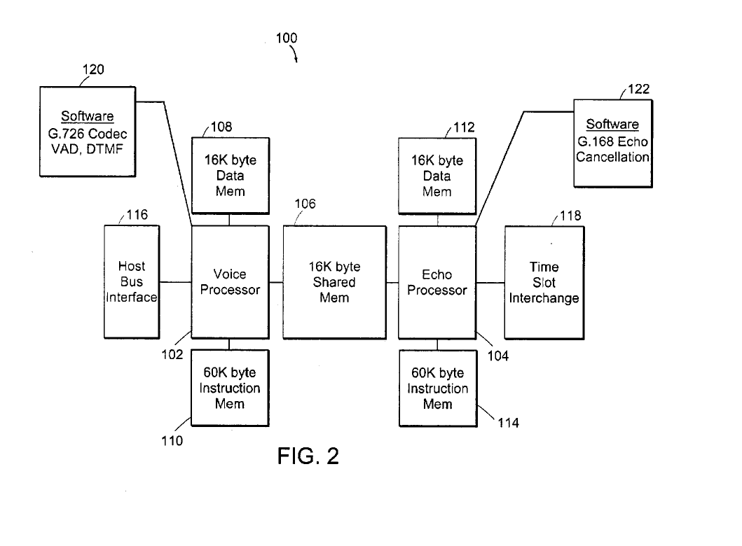

FIG. 2 illustrates a schematic block diagram of a multi-processor architecture 100 that includes a first task processor 102 and a second task processor 104 that are in communication with a distributed shared memory 106. The distributed shared memory 106 is in communication with each of the first 102 and the second task processors 104. Skilled artisans will appreciate that the invention can be used with architectures having any number of processors and any number of shared memories.

The first task processor 102 is also in communication with a private (i.e., not shared) data memory (PDM) 108 and a private instruction memory (PIM) 110. The second task processor 104 is also in communication with a private data memory 112 and a private instruction memory 114.

A host bus interface 116 is in communication with the first 102 and the second task processors 104. The host bus interface 11 6 couples the first 102 and the second task processors 104 to a global bus (not shown) for communicating on-chip task and control information between the first 102 and the second task processors 104. Additionally, a time slot interchange interface 118 is connected to the first 102 and the second task processors 104. In one embodiment, the time slot interchange interface 118 provides the ability to map timeslots to and from available PCM highways and internal PCM voice data buffers.

A first software program 120 is embedded in the first task processor 102. The first software program 120 contains instruction code that is executed by the first task processor 102. A second software program 122 is embedded in the second task processor 104. The second software program 122 contains instruction code that is executed by the second task processor 104.

In one embodiment, the multi-processor architecture 100 is a voice processing system (VPS). For example, the first task processor 102 can be a voice processor. In this example, the first software program 120 includes software code that enables, for example, voice activity detection (VAD), dual tone multi-frequency (DTMF) tones, and the ITU-T G.728 codec standard. For example, the second task processor 104 can be an echo processor. In this example, the second software program 122 includes software code that enables a particular echo cancellation standard, such as the ITU-T G.168 digital echo cancellation standard.

In one embodiment, the method and apparatus of the present invention generates one or more resource parameters 76 that are used to modify one or more program sections of the first 120 and/or the second software programs 122. For example, in one embodiment, modifying the one or more program sections includes reducing idle time in the units. In addition, the modification can include modifying one or more instruction words in the program section. Also, in one embodiment, modifying the one or more program sections includes removing one or more instruction words in the program section.

In one embodiment, the method and apparatus of the present invention use resource parameters 76 to modify the first 102 and/or the second processors 104. There are numerous types of resource parameters 76 that are know to persons skilled in the art. For example, one type of resource parameter 76 is a cost related to the hardware architecture 60. Another type of resource parameter 76 is related to a metric of power demand for the hardware architecture 60. Yet another type of resource parameter 76 is related to a metric of performance of the first 120 and/or the second software programs 122.

One example of the multi-processor architecture 100 is a 16-channel Back-Office VPS application. For example, the architecture 100 can use a voice codec (G.726) 102 and an echo canceller (G.168) 104 for voice processing. In this embodiment, the multi-processor architecture 100 uses DSP processors having one multiply-accumulate unit, one shifter unit, three Arithmetic and Logic Units (ALUs), and three memories.

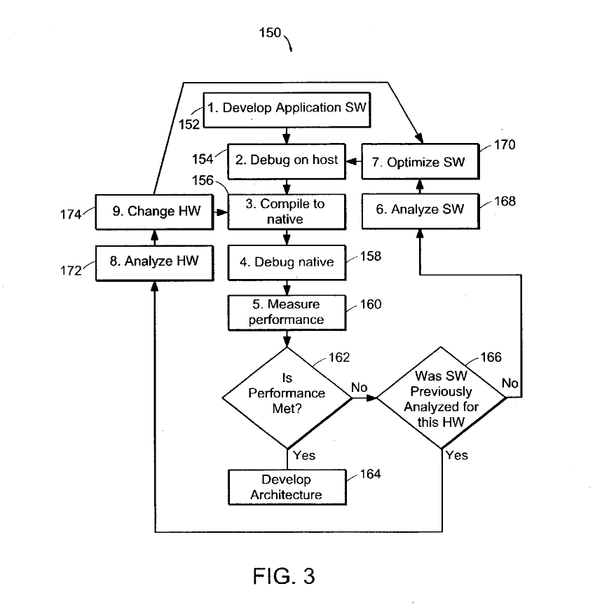

The methods and apparatus of the present invention evaluate interactions between software and configurable hardware and assist the designer in meeting performance targets before committing to production of the final silicon chip. FIG. 3 illustrates a flow chart of a method 150 for developing an ASP 62 according to one embodiment of the present invention. The method 150 includes the step 152 of creating the software application 52, which is a working software implementation of the application. In one embodiment, the software code is written in assembly language. In another embodiment, the software code is written using a high-level language, such as Java or C.

In one embodiment, the software code is written using a structured, object-based Notation environment (a high level verification and software development tool for embedded applications). In general, Notation describes an application as a collection of tasks that have related data and control dependencies. These characteristics make Notation an effective language for application design generally, and specifically for application design using configurable processors.

Once the application 52 is developed, the designer then verifies the software model. The method 150 includes the step 154 of debugging the software model on a host computer. Other types of verification of the software model known in the art can also be used. For example, software for testing the application 52 can use any of the facilities provided by the Java environment. In other embodiments, these facilities include rapid graphical user interface (GUI) development, charting/display objects, file input/output, and programmatic comparison and evaluation of data values. By using these facilities, designers can create robust test bench environments. In one embodiment, a software profiler 68 evaluates the application 52.

The method 150 also includes the step 156 of compiling the software model to native code onto a target platform. The method 150 also includes the step 158 of debugging the native code. In addition, the method 150 includes the step 160 of measuring the performance of the application 52.

The method 150 also includes the step 162 of determining whether the application 52 meets the performance requirements on the selected target platform. In one embodiment, a software profiler 68 is used to measure the performance of the application 52. The software profiler 68 can provide passive feedback to determine at least one resource parameter 76 that is related to the performance of the application 52 for the compiled program 66. The software profiler 68 can also provide active feedback to determine at least one resource parameter 76 that is related to the performance of the application 52. The resource parameter 76 can correspond to an available resource or a resource bottleneck.

If the application 52 meets the performance requirements on the selected target platform then the step 164 of developing the hardware architecture 60 is performed. However, if the application 52 does not meet the performance requirements on the selected target platform then the step 166 of determining whether the software was previously analyzed for the hardware architecture 60 is performed.

If the method 150 determines that the software was not previously analyzed for the hardware architecture 60 then the step 168 of analyzing the application 52 is performed. In one embodiment, the step 168 of analyzing the application 52 includes simulation of the overall number of cycles required for the application 52 with the applied data set. The visual framework 74 displays the minimum, maximum, average and overall number cycles used by each task for the designer. In another embodiment, the step 168 of analyzing the application 52 includes inserting breakpoints in the application 52 and displaying various performance data for the designer.

In one embodiment, the step 168 of analyzing the application 52 includes rerunning or re-simulating the software using a comprehensive test set with cycle estimates back annotated into the simulation. These estimates can be used, for example, to determine why the application 52 does not meet the performance requirements. In one embodiment, the back annotation is achieved by adding tags to the software code for each execution block and then updating the tags with the cycle count for each execution block after the code is compiled. In this way, the software code can then run and provide execution profile information on a host platform without performing simulation.

The method 150 also includes the step 170 of optimizing the software application program 52. The software application program 52 can be optimized in numerous ways depending on the specific application. For example, software algorithms contained within the application program 52 can be rewritten and/or data types can be changed. The method 150 then performs the step 154 of debugging on the host computer. The method 150 then performs the step 156 of compiling the optimized application program 52 to native code on the target platform. The method 150 then performs the step 158 of debugging the native code. In addition, the method 150 then performs the step 160 of re measuring the performance of the application 52.

The method 150 then performs the step 162 of determining whether the application 52 meets the performance requirements on the selected target platform. If the application 52 meets the performance requirements on the selected target platform then the step 164 of developing the hardware architecture 60 is performed. However, if the application 52 still does not meet the performance requirements on the selected target platform then the step 166 of determining whether the software was previously analyzed for the hardware architecture 60 is performed.

At this point in the method, the software was previously analyzed for the hardware architecture 60. The method then performs the step 172 of analyzing the hardware. In one embodiment, the step 172 of analyzing the hardware includes determining the specific resources used, such as the overall utilization by each processor, the overall resource use within a given process, the resource use on an instruction-by-instruction basis, and the memory utilization in each on-chip memory. The software profiler 68 can provide this information as one or more resource parameters 76.

The method 150 also includes the step 174 of changing the hardware. In one embodiment, the step of changing the hardware includes modifying resources on the target platform, such as the processors, computational units (CUs) and memory interface units (MIUs). These changes can lead to increases in efficiency in the areas of performance, die size and/or power characteristics.

The method 150 then performs the step 170 of re-optimizing the application program 52 depending on the changes to the hardware architecture 60. The method then performs the step 154 of debugging the re-optimized application program 52 on the host. In addition, the method then performs the steps of compiling the native code (step 156) and debugging the native code (step 158). The method then performs the step 160 of re-measuring the performance. This method 150 is iterated until all of the required constraints are met including performance, die size, and power characteristics.

In one embodiment, the methods and apparatus of the present invention provide both visual and pro-active feedback to the designer. The visual feedback includes both qualitative (graphical) and quantitative (numeric) analysis of a software application 52 running on a specified processor configuration. A profiler 68 can provide this analysis by profiling the software application 52 as described herein.

In one embodiment, the methods and apparatus of the present invention provide feedback for particular hardware elements such as processors or task engines. In one embodiment, the methods and apparatus of the present invention provide feedback for particular sections of code. In these embodiments, performance feedback can be provided for particular instruction cycles. Dynamic and static resource utilization charts (at varying degrees of granularity) can be displayed. Performance feedback can also include cyclic and acyclic dependence chain analysis that can provide a lower bound on performance. By using this information, the designer can isolate execution bottlenecks and gain insight into the cause of the execution bottlenecks.

By visualizing and understanding the execution bottlenecks, a designer can improve the synergy between the hardware and the software. In one embodiment, the invention provides proactive feedback to the designer in the form of suggestions 78 relating to reconfiguring or augmenting the processor to meet cost versus performance objectives.

For example, the feedback can include data layout suggestions 78 to improve performance. The feedback can also include instruction slot mappings to decrease instruction width without negatively impacting performance. The feedback can also include identification of units that can be eliminated without significantly impacting performance and/or identification of units that can be added to improve performance. The feedback can be given in the form of estimates of the performance to be gained by certain changes in the hardware. In addition, the feedback can include potential source-level improvements, such as using so-called “range assertions” to enable more aggressive (less conservative) optimization by the compiler 54.

In one embodiment, the visualization provided to the designer is in the form of a visual representation of resource utilization on the various processors. The methods and apparatus of the present invention can analyze the match between the application 52 and the processors, and suggest configuration changes that can increase performance. The methods and apparatus of the present invention can also analyze resources that are under-utilized, and can suggest specific VLIW slot overlays for designers that desire to decrease instruction word width. For example, the methods and apparatus of the present invention can suggest changes to the memory layout to increase memory bandwidth.

A large number of DSP algorithms follow the 90/10 rule that states that ninety percent (90%) of program execution time is taken up by ten percent (10%) of the software code. Typically, the 10% of the code represents tight loops and programmers attempt to modify these tight loops in an effort to meet performance goals. In one embodiment, the methods and apparatus of the present invention assist designers in identifying these highly executed blocks of code. The methods and apparatus of the present invention can also assist the designers in speeding up the execution of these blocks, either by suggesting changes in the software code, suggesting changes to the hardware, or suggesting changes to both the software code and the hardware.

In one embodiment, to identify the highly executed blocks of code, the methods and apparatus of the present invention use profile information. For example, each basic block in the code can be matched with the number of cycles that a single execution of the block requires and the number of times that the block is executed.

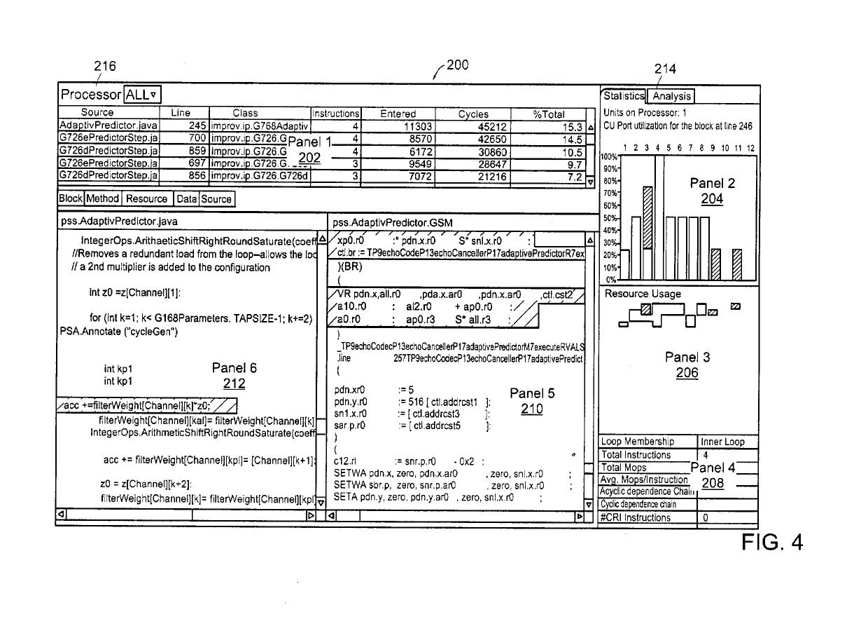

FIG. 4 illustrates a graphical display 200 showing various panels indicating performance parameters of a 16-channel Back-Office VPS (at 100 MHz) application that was described in connection with FIG. 2. The graphical display 200 includes a first panel 202 that is presented in a spreadsheet format. The spreadsheet allows the designer to sort data using different sorting criteria. For example, the first panel 202 allows the designer to easily navigate to different basic blocks of interest.

Once a specific basic block is chosen, all other information panels are automatically populated with related information. For example, in the embodiment shown, a second panel 204 displays the static utilization of hardware resources in the chosen block. The third panel 206 displays per-cycle utilization that correlates specific assembly and dependence chains to the various resources. The fourth panel 208 displays summary information of the chosen block. The fifth panel 210 displays the resulting assembly code corresponding to the chosen basic block. The sixth panel 212 displays the source code corresponding to the chosen basic block.

The summary information is collected during compilation of the source code. The summary information displayed on the fourth panel 208 includes statistics, such as the total cycles and the number of operations per cycle, the flow type of block (i.e., inner loop, outer loop, etc.), the length of the dependence chain, and the presence of cyclic dependencies. The designer can determine from this information whether the execution of the basic block can be improved by using different hardware. For example, hardware bottlenecks can be identified by determining if the length of the dependence chain in the block (or the cyclic dependence chain in loops) is smaller than the number of cycles required by the block execution.

Using the methods and apparatus of the present invention, the designer can also correlate the assembly code with the source code and analyze the match between hardware and software. For example, the designer can highlight a line in the Java code and the corresponding assembly code is automatically highlighted. This allows the designer to easily correlate the assembly code with the Java code. Additionally, windows that display statistics and analysis are also automatically updated with relevant information that can be utilized by the designer. Additionally, the methods and apparatus of the present invention can indicate the hardware resources that are most likely blocking the execution.

The utilization graph displayed on the second panel 204 shows the usage of each hardware resource. Any utilized resource in a pipelined loop can be a blocking resource unless the loop has a cyclic dependency blocking further optimization. In one embodiment, a seventh panel 214 is provided that is an analysis panel. In one embodiment, the analysis panel displays those resources deemed by the compiler 54 to be blocking execution. The analysis panel can also display an estimate of the performance gain should the execution bottleneck be resolved.

For the voice processing system example described herein, the first panel 202 indicates that a block 216 in the Adaptive Predictor source code is taking up 15.3% of the application execution time. The fourth panel 208 indicates that the source code is an inner loop with no cyclic dependencies. A branch in the code contains one latency, which indicates that the loop should execute in two cycles. However, the fourth panel 208 indicates that the loop requires four cycles to execute. Additionally, the second panel 204 indicates that slot four is 100% utilized by the Multiply Accumulate Unit (indicated by mp0).

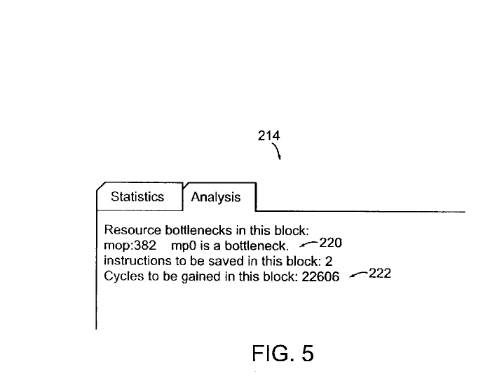

FIG. 5 illustrates an example of an analysis panel 214 according to an embodiment of the invention. The analysis panel 214 indicates that the Multiply Accumulate Unit (mp0) is a bottleneck 220 in the block of FIG. 4. The analysis panel 214 also provides an estimate 222 of the number of cycles to be gained by adding an additional Multiply Accumulate Unit. In this example, the analysis panel 214 indicates that 22,606 cycles can be gained by adding an additional Multiply Accumulate Unit.

Any change in the hardware is likely to affect multiple blocks. Thus, in one embodiment, the invention provides an estimate of the effect of adding or removing resources on the overall performance of the application. The estimate provides information that allows designers to add or remove resources without having to create a new configuration and receive results after each compilation.

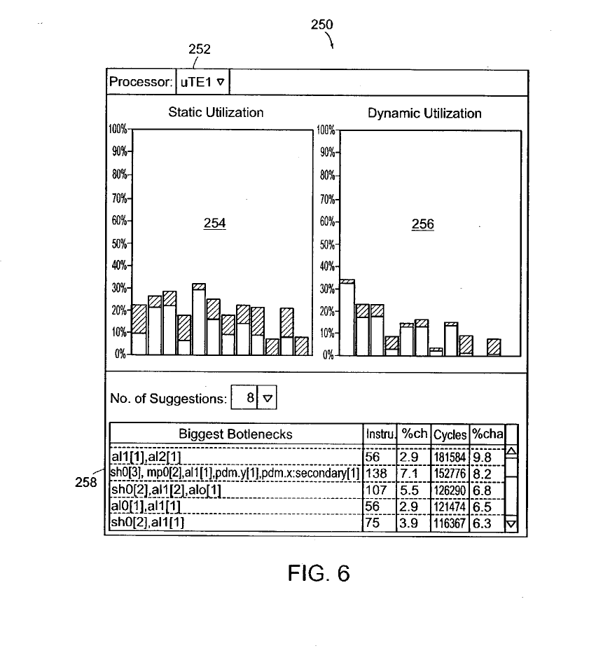

FIG. 6 illustrates a graphical display 250 indicating a performance analysis that includes static and dynamic utilization for a specific system processor 252 according to an embodiment of the present invention. Specifically, the graphical display 250 indicates a static utilization panel 254, a dynamic utilization panel 256, and a resource bottlenecks analysis panel 258. The static utilization panel 254 illustrates static resource usage for all of the tasks executed in the processor 252 in graphical form. The dynamic utilization panel 256 illustrates dynamic resource usage for all of the tasks executed in the processor 252 in graphical form.

The resource bottlenecks analysis panel 258 includes a spreadsheet view of the largest resource bottlenecks found in the processor 252 including their effect on program size and performance. The estimates illustrated on the resource bottlenecks analysis panel 258 predict the effect of adding multiple resources over the entire program rather than over a single block. In addition, resources that affect many insignificant blocks are also revealed.

For the voice processing system example described herein, the Adaptive Predictor is the single most significant block. By adding a multiplier, the number of cycles that this block requires to execute can be reduced by approximately 22,000 cycles. However, analysis indicates that many blocks will benefit from the addition of an ALU. Analysis also indicates that the cumulative result of adding an ALU is that the number of cycles can be reduced by approximately 10,000 cycles. In addition, analysis indicates that two of the memories are used for reads only, and never used for writes. This information can allow a designer to select memories having read-only ports for these two memories, thus decreasing the cost and reducing the size of the processor.

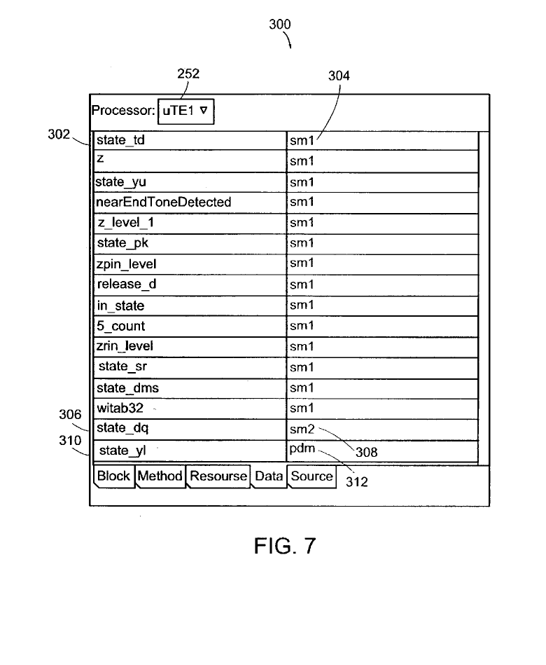

FIG. 7 illustrates a graphical display 300 indicating data allocation suggestions 78 for the voice processing system example described herein. The data allocation can indicate memory related bottlenecks. Such bottlenecks can be resolved by redistributing the data elements to different memories. In one embodiment, the methods and apparatus of the present invention provide memory allocation suggestions 78 based on profile information.

The graphical display 300 can illustrate a specific memory location for each data element. In one embodiment, these suggestions 78 are based on profiling information and memory bandwidth requirements. For example, data associated with “state_td” 302 should be allocated to shared memory one (sm1) 304. Data associated with “state_dq” 306 should be allocated to shared memory two (sm2) 308. Additionally, data associated with “state_yl” 310 should be allocated to private data memory (pdm) 312.

VLIW architectures can support flexible program or instruction word size. Architectures that support various program and instruction word sizes allow the designer to efficiently use instruction memory. However, these architectures force the designer to make certain performance compromises. For example, architectures that support various program and instruction word sizes may have reduced parallelism. A complicated decoding stage may be required that can result in deeper pipelining. In one embodiment, the methods and apparatus of the present invention can assist the designer in determining the optimal instruction word size.

VLIW architectures can also support instruction compression. Instruction compression can improve instruction memory usage efficiency. In general, reducing the instruction word reduces the complexity of the associated instruction memory hardware. However, instruction compression is not very effective when the associated code is control flow intensive. Instruction compression may also require a higher complexity decoding stage. In one embodiment, the methods and apparatus of the present invention can provide information to a designer that assists in determining the optimal instruction word size.

In one embodiment, the methods and apparatus of the present invention assists the designer in finding the correct units to overlay such that the instruction width is within bounds and the performance penalty is minimized. In one embodiment, the methods and apparatus of the present invention select the units to use, the number of VLIW slots, and the correct organization for the units in the slots. To accomplish this resource overlay, the methods and apparatus collect data on functional unit usage during scheduling. The designer then inputs the desired instruction word length, and the methods and apparatus correlate the data collected with profile information to find a distribution of functional units to slots that are likely to maximize parallelism, while achieving the best performance for the application.

VLIW architectures typically have resources available for parallel execution. Increasing the number of resources available for parallel execution can increase the performance of the processor. However, increasing the number of resources available for parallel execution can result in a larger memory footprint. In one embodiment, the methods and apparatus of the present invention can assist a designer in determining the number of resources available for parallel execution.

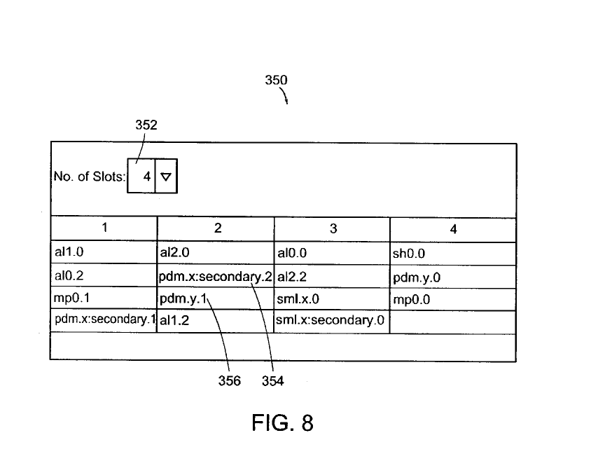

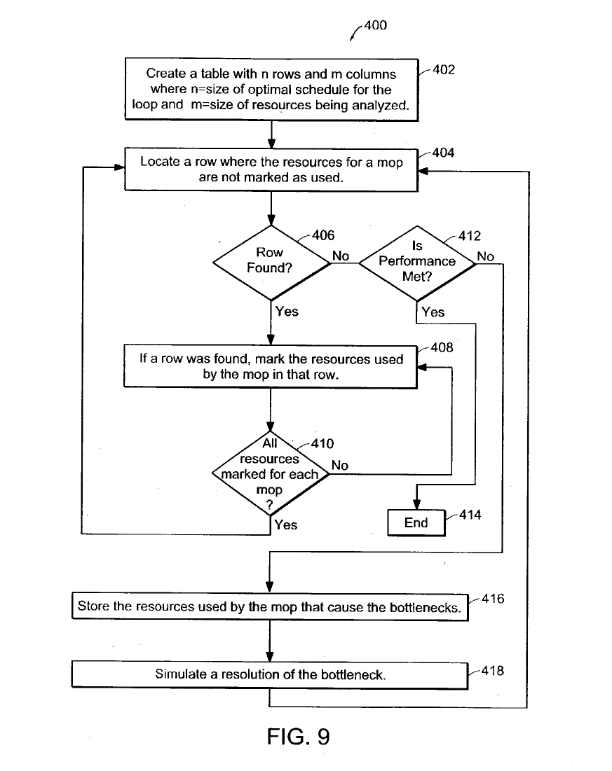

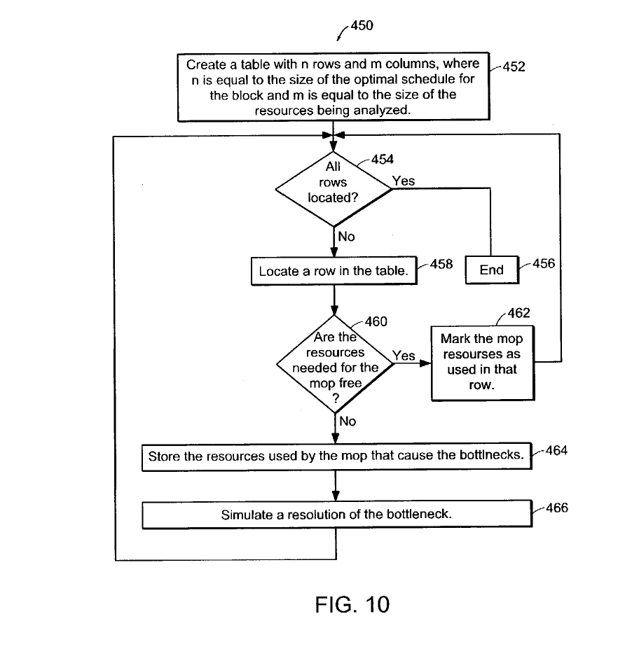

FIG. 8 presents an example of a suggested configuration 350 for a system according to the present invention that will reduce bottlenecks. The example shows a configuration 350 that has four slots selected 352. The configuration is the result of the analysis described herein in connection with FIGS. 9 and 10.

The analyzer 64 collects data on resource usage during scheduling. A designer then inputs the desired instruction word length into the analyzer 64, and the analyzer 64 correlates the data collected with profile information to determine the optimal distribution of units to slots. In this example, selecting four slots generates an allocation that results in a minimal number of resource conflicts.

The analyzer 64 indicates the effect on performance caused by selecting the four slots. For example, the analyzer 64 can indicate less obvious overlaps, such as the fact that it is least damaging to overlay both slots of the pdm MIU 354, 356. The pdm memory is used for both read and write operations. However after scanning all of the execution blocks and factoring in profile information, the analyzer 64 determines that those read and write operations are not typically executed in parallel.

FIG. 9 illustrates a flowchart of a method 400 for finding resource bottlenecks in pipelined loops according to an embodiment of the present invention. The method 400 includes the step 402 of creating a table that has n rows and m columns, where n is equal to the size of the optimal schedule for the pipelined loop and m is equal to the size of the resources being analyzed. In one embodiment, the optimal schedule corresponds to the maximum cyclic dependence in the schedule.

The method 400 then performs the step 404 of locating a row where the resources for a mop are not marked as used. The method 400 then performs the step 406 of determining if the row was found. If the row was found, then the method 400 performs the step 408 of marking the resources as used by the mop in that row.

The method 400 then performs the step 410 of determining if all resources are marked for each mop. If the method 400 determines that all resources are marked for each mop, then the method 400 repeats from step 404 and another row is located where the resources for a mop are not marked as used. If the method 400 determines that all resources are not marked for each mop, then the method repeats step 408 and resources used by the mop are marked in the row.

If the row was not found in step 406, then the step 412 of determining if the performance is met is performed. If the step 412 determines that the performance is met, then the method 400 is terminated at step 414. However, if the step 412 determines that the performance is not met, then the step 416 of storing the resources used by the mop that are causing the bottleneck is performed.

The method 400 then performs the step 418 of simulating a resolution of the bottleneck. In one embodiment, the step 418 includes clearing those resources from all of the rows in the table. Clearing the resources from all of the rows in the table simulates adding additional resources of the types that created the bottleneck. The method 400 then repeats from step 404 and another row is located where the resources for a mop are not marked as used.

FIG. 10 illustrates a flow chart of a method 450 according to an embodiment of the present invention for finding resource bottlenecks for any block that is not part of a pipelined loop. The method 450 includes the step 452 of creating a table that has n rows and m columns, where n is equal to the size of the optimal schedule for the block and m is equal to the size of the resources being analyzed. In one embodiment, the optimal schedule corresponds to the maximum dependence graph height.

The method 450 also includes the step 454 of determining if all the rows in the table have been located. If the step 454 determines that all the rows in the table have been located, then the method 450 is terminated. However, if the step 454 determines that all the rows in the table have not been located, then the method 450 performs the step of locating a row in the table.

The method 450 then performs the step 460 of determining if all resources needed for the mop in that row are free. If the step 460 determines that all the resources needed for the mop in that row are free, then the step 462 of marking the mop resources as used in that row is performed. The method 450 then repeats from step 454.

However, if the step 460 determines that all the resources needed for the mop in that row are not free, then the step 464 of storing the resources used by the mop that are causing the bottleneck is performed. The method 450 then performs the step 466 of simulating a resolution of the bottleneck. In one embodiment, the step 466 includes clearing those resources from all of the rows in the table. Clearing the resources from all of the rows in the table simulates adding additional resources of the types that created the bottleneck. The method 450 then repeats from step 454.

Skilled artisans will appreciate that many additional methods are within the scope of the present invention. For example, the methods and apparatus of the present invention can include estimating the result of resolving bottlenecks over multiple blocks. Methods and apparatus according to the present invention can also include determining the most critical bottlenecks over all blocks allocated on a specific processor. In addition, the methods and apparatus of the present invention can include determining the best combination of slots that reduce the amount of resource bottlenecks.

Skilled artisans will appreciate that by analyzing the code and by applying several optimization methods, methods and apparatus according to the present invention can generate recommendations for economical hardware modifications that effectively boost the application performance.

While the invention has been particularly shown and described with reference to specific embodiments, it should be understood by those skilled in the art that various changes in form and detail may be made therein without departing from the spirit and scope of the invention.

1. An apparatus comprising a computer system for optimizing a hardware architecture having an application specific processor, the computer system comprising:
a simulator that models the application specific processor to generate a simulated hardware architecture; and
a profiler in communication with the simulator, the profiler analyzing a compiled program for the simulated hardware architecture to determine a resource parameter for a program section of the compiled program,
wherein the profiler provides a suggestion for modifying at least one of the application specific processor and the program section in response to the resource parameter to optimize at least one of the compiled program and the hardware architecture.

2. The apparatus of claim 1 wherein the resource parameter comprises a cost related to the hardware architecture.

3. The apparatus of claim 1 wherein the resource parameter comprises a power demand for the hardware architecture.

4. The apparatus of claim 1 wherein the resource parameter comprises a measure of performance of the compiled program.

5. The apparatus of claim 1 wherein the profiler that analyzes the compiled program analyzes the compiled program prior to execution of the compiled program on the simulated hardware architecture.

6. The apparatus of claim 1 wherein the profiler that analyzes the compiled program analyzes the compiled program during execution of the compiled program on the simulated hardware architecture.

7. The apparatus of claim 1 wherein the profiler that analyzes the compiled program analyzes the compiled program subsequent to execution of the compiled program on the simulated hardware architecture.

8. The apparatus of claim 1 wherein the profiler provides passive feedback to determine the resource parameter for at least one program section of the compiled program.

9. The apparatus of claim 1 wherein the profiler provides active feedback to determine the resource parameter for at least one program section of the compiled program.

10. The apparatus of claim 1 wherein the application specific processor is modified by configuring the application specific processor.

11. The apparatus of claim 1 wherein the resource parameter comprises a resource bottleneck.

12. The apparatus of claim 1 wherein the resource parameter comprises an available resource.

13. The apparatus of claim 1 wherein the profiler indicates a resource bottleneck.

14. The apparatus of claim 13 wherein the resource bottleneck is visually indicated.

15. The apparatus of claim 13 wherein the resource bottleneck is audibly indicated.

16. The apparatus of claim 1 wherein the compiled program comprises a very long instruction word program.

17. The apparatus of claim 1 wherein the suggestion for modifying the program section comprises reducing idleness in the program section.

18. The apparatus of claim 1 wherein the suggestion for modifying the program section comprises changing at least one instruction word in the program section.

19. The apparatus of claim 1 wherein the suggestion for modifying the program section comprises removing at least one instruction word in the program section.

20. The apparatus of claim 1 further comprising a graphical user interface that displays the resource parameter.

21. The apparatus of claim 1 further comprising a graphical user interface that displays the simulated hardware architecture.

22. The apparatus of claim 1 further comprising a compiler that generates the compiled program for the simulated hardware architecture.

23. The apparatus of claim 1 wherein the hardware architecture comprises at least one application specific processor.

24. The apparatus of claim 1 wherein the profiler analyzes the compiled program for the simulated hardware architecture to determine at least one resource parameter for at least one program section of the compiled program.

25. A method for optimizing a hardware architecture having an application specific processor, the method comprising:
modeling the application specific processor to generate a simulated hardware architecture;
analyzing a compiled program for the simulated hardware architecture to determine a resource parameter for a program section of the compiled program; and
providing a suggestion for modifying at least one of the application specific processor and the program section in response to the resource parameter to optimize at least one of the compiled program and the hardware architecture.

26. The method of claim 25 wherein the resource parameter comprises a cost associated with the hardware architecture.

27. The method of claim 25 wherein the resource parameter comprises a power requirement for the hardware architecture.

28. The method of claim 25 wherein the resource parameter comprises a measure of performance associated with the compiled program.

29. The method of claim 25 wherein the analyzing the compiled program to determine the resource parameter for the program section of the compiled program comprises analyzing the compiled program prior to executing the compiled program on the simulated hardware architecture.

30. The method of claim 25 wherein the analyzing the compiled program to determine the resource parameter for the program section of the compiled program comprises analyzing the compiled program during execution of the compiled program on the simulated hardware architecture.

31. The method of claim 25 wherein the analyzing the compiled program to determine the resource parameter for the program section of the compiled program comprises analyzing the compiled program subsequent to execution of the compiled program on the simulated hardware architecture.

32. The method of claim 25 wherein the analyzing the compiled program comprises providing passive feedback to determine the resource parameter for the program section of the compiled program.

33. The method of claim 25 wherein the analyzing the compiled program comprises providing active feedback to determine the resource parameter for the program section of the compiled program.

34. The method of claim 25 wherein the providing the suggestion for modifying the at least one of the application specific processor and the program section comprises providing at least one suggestion for modifying a configuration of the application specific processor.

35. The method of claim 25 wherein the resource parameter comprises a resource bottleneck.

36. The method of claim 25 wherein the resource parameter comprises an available resource.

37. The method of claim 25 wherein the analyzing the compiled program comprises indicating a resource bottleneck.

38. The method of claim 37 wherein the resource bottleneck is visually indicated.

39. The method of claim 37 wherein the resource bottleneck is audibly indicated.

40. The method of claim 25 wherein the compiled program comprises a very long instruction word program.

41. The method of claim 25 wherein the providing the suggestion for modifying the at least one of the application specific processor and the program section comprises providing a suggestion for reducing idleness in the program section.

42. The method of claim 25 wherein the providing the suggestion for modifying at least one of the application specific processor and the program section comprises providing a suggestion for modifying at least one instruction word in the program section.

43. The method of claim 25 wherein the providing the suggestion for modifying the at least one of the application specific processor and the program section comprises providing a suggestion for removing at least one instruction word in the program section.

44. The method of claim 25 wherein the hardware architecture comprises at least one application specific processor.

45. The method of claim 25 wherein the analyzing the compiled program comprises analyzing the compiled program to determine at least one resource parameter for at least one program section of the compiled program.

46. The method of claim 25 further including generating the compiled program for the simulated hardware architecture.

47. An apparatus for optimizing a hardware architecture including at least one application specific processor, the apparatus comprising:
means for modeling the at least one application specific processor to generate a simulated hardware architecture;
means for analyzing a compiled program for the simulated hardware architecture to determine a resource parameter for at least one program section of the compiled program; and
means for providing a suggestion for modifying at least one of the at least one application specific processor and the at least one program section in response to the resource parameter to optimize at least one of the compiled program and the hardware architecture.
